(19) United States
(12) Patent Application Publication
(10) Pub. No.: US 2024/0416993 A1
(43) Pub. Date: Dec. 19, 2024

(54) UTILITY VEHICLE WITH HYDROSTATIC STEERING

(71) Applicant: DEERE & COMPANY, MOLINE, IL (US)

(72) Inventor: STEFAN BROCKE, MANNHEIM (DE)

(21) Appl. No.: 18/665,803

(22) Filed: May 16, 2024

(30) Foreign Application Priority Data
Jun. 15, 2023 (DE) 102023115610.1

(51) Int. Cl. B62D 6/00; B62D 5/10

(52) U.S. Cl. CPC B62D 6/00; B62D 5/10

(57) ABSTRACT

A utility vehicle with hydrostatic steering includes a steering wheel which is mechanically separate from the wheels of a vehicle axle, a hydraulic steering control unit via which a hydraulic pressure can be conducted into a hydraulic steering cylinder of a steering device for the wheels according to a rotational movement of the steering wheel, an input angle sensor configured to detect a rotational movement of the steering wheel, an output steering column, which is mechanically separate from the steering wheel, can be rotated via a steering actuator and acts on the hydraulic steering control unit, and a control unit connected to the input angle sensor and to the steering actuator to activate the steering actuator according to sensor signals of the input angle sensor.

### CROSS-REFERENCE TO RELATED APPLICATIONS

This application claims priority to German Patent Application No. 102023115610.1, filed Jun. 15, 2023, which is hereby incorporated by reference.

### FIELD OF THE DISCLOSURE

The disclosure relates to a utility vehicle with hydrostatic steering.

### BACKGROUND

Vehicle steering systems include a steering wheel, by means of which a steering metering valve in the form of an orbitrol, fed from a hydraulic pump with pressurized hydraulic fluid, can be actuated in order to control a connected hydraulic steering cylinder for adjusting steerable wheels of the vehicle.

### SUMMARY

The disclosure relates to a utility vehicle having a steering wheel, which is mechanically separate from the wheels of a vehicle axle, and having a hydraulic steering control unit, via which a hydraulic pressure can be conducted into a hydraulic steering cylinder of a steering device at the vehicle axle according to a rotational movement of the steering wheel.

A steering system of this type enables so-called hydrostatic steering of the utility vehicle, in which the driver is relieved of high steering forces.

The present disclosure is based on the object of further improving a utility vehicle in terms of its steering system.

This object is achieved by a utility vehicle having the features of one or more of the following embodiments.

Further advantageous refinements of the utility vehicle according to the disclosure can be found in one or more of the following embodiments.

According to an embodiment, a utility vehicle with hydrostatic steering has a steering wheel, which is mechanically separate from the wheels of a vehicle axle, and a hydraulic steering control unit (e.g. steering orbitrol), via which a hydraulic pressure can be conducted into a hydraulic steering cylinder of a steering device according to a rotational movement of the steering wheel. The steering device is located in the region of the vehicle axle and steers the wheels thereof. A rotational movement or steering movement of the steering wheel can be detected by an input angle sensor here. An output steering column, which is mechanically separate from the steering wheel, can be rotated via a steering actuator (e.g. electric motor) and acts on the hydraulic steering control unit. A control unit is connected to the input angle sensor and to the steering actuator in such a way that the control unit activates the steering actuator according to received sensor signals of the input angle sensor.

For the hydraulic steering control unit, it is for example possible to use functional units which are available as standard (e.g. steering orbitrols) so that the required hydraulic pressures or volume flows may be conducted to the steering cylinder(s) in a technically reliable manner. The hydraulic steering control unit and the output steering column acting thereon are combined with the signal-processing electronic control unit and the input angle sensor via the steering actuator. As a result, in a technically simple and efficient manner, hydrostatic steering may be combined with a control system in which a steering command of the steering wheel is conveyed to the steering actuator electrically via the control unit. With little technical effort, this control system, the structure of which may at least partly correspond to a so-called steer-by-wire system, provides the basis for combining the advantages of hydrostatic steering with greater steering comfort, easier vehicle handling and the option of an autonomous steering mode.

The utility vehicle is for example designed as a utility vehicle for agricultural or forestry use (e.g. tractor) or as a construction machine.

The steering device, which is connected to the hydraulic steering cylinder(s) and arranged in the region of the vehicle axle, may comprise conventional components, such as track rod(s), track rod joints and steering knuckles. The steering cylinder is for example designed as a double-acting cylinder, in particular a synchronized cylinder, and has hydraulic connections for the connection of the hydraulic steering control unit. The steering cylinder is mechanically connected to the steering device via a piston rod or two adjacent piston rods.

In an embodiment, an output angle sensor is provided, which is connected to the control unit. The output angle sensor may detect a rotational movement of the output steering column so that the rotational behavior of the output steering column is monitored by the control unit. This facilitates a steering control which acts in a technically precise manner.

Further, the steering wheel can be rotated via an input actuator (e.g. an electric motor), which is connected to the control unit or can be activated by the control unit. As a result, the control unit may send feedback to the steering wheel depending on the current route and vehicle state. The driver therefore receives the feedback customary in conventional steering systems. This promotes the driving and steering comfort of the utility vehicle. In this regard, the input actuator may be used for different applications, for instance active steering wheel reset (e.g. into a straight-ahead position), speed-dependent steering feedback, route-dependent steering, steering corrections when driving straight ahead, haptic realization of a steering end-stop.

A rotational movement of the steering wheel can for example be detected by a torque sensor, which is connected or linked to the control unit. As a result, the control unit may take into account additional signals for technically precise steering control and for sending feedback which is representative of the driving situation to the steering wheel and the driver.

To rotate the steering wheel, the input actuator may act on the steering wheel directly or indirectly. For indirect rotation, the input actuator for example acts on an extension of the steering wheel hub, which is mechanically separate from the output steering column. In particular, the input actuator acts on an input steering column, which is connected to the steering wheel in a rotationally fixed manner and is mechanically separate from the output steering column. Moreover, rotational movements of the input steering column may be detected by the input angle sensor and/or the torque sensor in order to detect or identify rotational movements of the steering wheel in a technically simple manner.

Further, the steering actuator and the input actuator are supplied with electrical energy for their operation. In particular, these functional units are designed as electric motors. For electrically reliable operation, the electrical actuators may be electrically connected to a generator and/or to an electrical storage unit (e.g. battery, rechargeable battery) in the utility vehicle. In particular, the actuators are connected to both electrical sources—i.e. to the generator and to the electrical storage unit-so that suitable supply redundancy is ensured in the event of a technical failure.

The above-mentioned supply redundancy is for example improved in that the generator is connected to a storage unit input of the electrical storage unit.

In a further embodiment, the steering actuator acts on a steering orbitrol of the hydraulic steering control unit in that the steering actuator is activated by the electronic control unit for a rotational movement or rotation in order to actuate the output steering column and therefore also the steering orbitrol. As a result, the hydraulic pressure for the steering cylinder(s) may also be generated. The steering orbitrol is, in particular, integrated within the hydraulic steering control unit and mechanically combined with the output steering column. The electronic control unit with the steering actuator may thus provide a supply redundancy in the event of a failure of a hydraulic main pump of the utility vehicle, which usually generates the required hydraulic pressure.

Further, the electronic control unit is connected to an automatic unit, which is connected to a user interface (e.g. screen, data input unit) and/or to a position detection system (e.g. GPS) and/or to a vehicle-related control device of the utility vehicle. The vehicle-related control device may for example detect or process vehicle-related physical variables and states. It is, in particular, connected to a communications bus (e.g. ISO, CAN) of the utility vehicle. The data connection to the automatic unit enables the electronic control unit to take into account additional data for the steering control, for instance current vehicle-related states (e.g. current vehicle speed) and settings defined via the user interface. As a result, a desired steering ratio may also be achieved or altered in a technically more simple manner, whereby the steering effort may be advantageously reduced and the steering precision improved. The processing of position data and further vehicle-related physical variables of the utility vehicle in the electronic control unit also enable an autonomous steering mode in a technically simple manner. The control unit here receives corresponding data or signals from the above-mentioned automatic unit. In the autonomous steering mode, the input actuator, and therefore also the steering wheel, are for example stationary.

In particular, the control unit is connected to a steering angle sensor arranged in the region of the vehicle axle. As a result, the steering control may take into account the current steering angle of the utility vehicle in a technically simple manner, whereby more precise steering may be realized in the autonomous steering mode, for example.

In a further embodiment, the hydraulic steering control unit is hydraulically interconnected between a hydraulic pump or main pump, driven by a drive motor of the utility vehicle, and the steering cylinder(s) which is/are present. This technically proven hydraulic arrangement of the different functional units facilitates efficient steering control of the utility vehicle.

The above and other features will become apparent from the following detailed description and accompanying drawings.

### BRIEF DESCRIPTION OF THE DRAWINGS

The utility vehicle according to the disclosure will be explained in more detail below with reference to the appended drawings.

FIG. 1 shows a schematically illustrated example embodiment of the hydrostatic steering device, according to the disclosure.

### DETAILED DESCRIPTION

The embodiments or implementations disclosed in the above drawings and the following detailed description are not intended to be exhaustive or to limit the present disclosure to these embodiments or implementations.

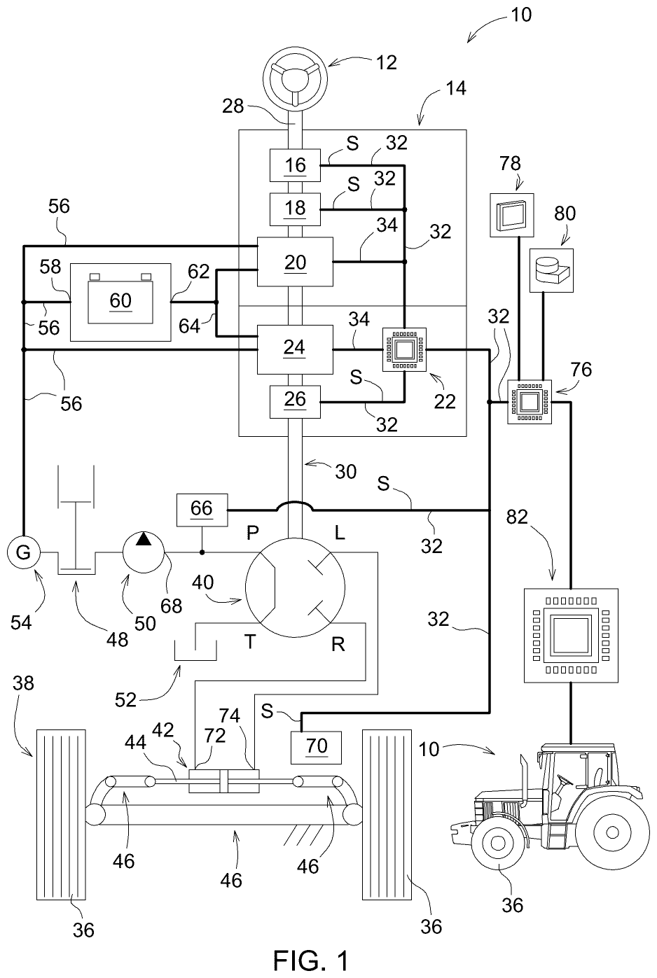

FIG. 1 shows an agricultural utility vehicle 10, in particular a tractor, having a steering wheel 12 and a steering control 14 comprising a plurality of functional units. In particular, the steering control 14 comprises an input angle sensor 16, a torque sensor 18, an input actuator 20, an electronic control unit 22 (e.g., a controller including a processor and memory), a steering actuator 24 and an output angle sensor 26.

The input actuator 20 is activated by the control unit 22 and may actuate an input steering column 28 connected to the steering wheel 12 in a rotationally fixed manner. The steering actuator 26 is also activated by the control unit 22 and may actuate an output steering column 30. Whilst rotational movements of the input steering column 28 are detected by the input angle sensor 16, rotational movements of the output steering column 30 are detected by the output angle sensor 26. The sensor signals S of the sensors 16, 26 are sent to the control unit 22 via data lines of a line network 32 and are processed in the control unit 22. The control unit 22 activates the two actuators 20, 24 via control lines 34.

The steering control 14 serves to steer the wheels 36 of a front vehicle axle 38 of the utility vehicle 10. Starting from the steering wheel 12, user-controlled steering takes place via the steering control 14, a hydraulic steering control unit 40, a hydraulic steering cylinder 42 and the piston rod(s) 44 thereof, which piston rod(s) is or are mechanically connected to a steering device 46 for the wheels 36.

The steering wheel 12 is mechanically separate from the wheels 36. The input steering column 28 and the output steering column 30 are likewise mechanically separate from one another.

The hydraulic steering control unit 40 is interconnected between a hydraulic pump 50 driven by a drive motor 48 (in particular an internal combustion engine) of the utility vehicle 10 and the steering cylinder 42. The hydraulic functional units 40, 42 are therefore integrated in a hydraulic circuit with the hydraulic pump 50 and a hydraulic container 52 (tank).

The drive motor 48 drives a generator 54, which is electrically connected to the two actuators 20, 24 and to a storage unit input 58 of an electrical storage unit 60 via supply lines 56. A storage unit output 62 of the storage unit 60 is likewise electrically connected to the two actuators 20, 24 via further supply lines 64, which actuators are designed, in particular, as electric motors.

A pressure sensor 66 detects a hydraulic pressure at a pump output 68 of the hydraulic pump 50. Corresponding sensor signals S of the pressure sensor 66 are sent to the control unit 22 via a data line of the line network 32.

A steering angle sensor 70 is arranged in the region of the vehicle axle 38 or in the region of the steering device 46 and its sensor signals S are sent to the control unit 22 via a data line of the line network 32.

The output steering column 30 is mounted on the steering control unit 40, which output steering column 30 is connected to a steering orbitrol 40 in a conventional manner and delivers hydraulic fluid to the steering cylinder 42 according to an actuation of the steering actuator 26. The steering orbitrol 40 may also be used to conduct sufficient hydraulic pressure to the steering cylinder 42 in the event of a fault at the hydraulic pump 50. The steering control unit 40 has hydraulic connections P, T, R, L. The pump output 68 (P), the hydraulic container 52 (T) and two cylinder connections 72, 74 (R, L) are hydraulically connected thereto.

The control unit 22 is connected to an automatic unit 76, similar to a control module, via the line network 32. The automatic unit 76 (e.g., a controller including a processor and memory) is in turn connected to various components of the utility vehicle 10, for instance to a user interface 78 for visually displaying data for a user and for a user to input data, a position detection system 80 (e.g. GPS) and a vehicle-related control device 82, which may detect and/or control various vehicle functions, for example, and may be connected to an on-board communications bus (e.g. ISO, CAN).

An autonomous steering mode, in which the steering wheel 12 and the input actuator 20 are stationary, may be realized via the automatic unit 76. The automatic unit 76 sends corresponding control signals to the control unit 22 here, which, in addition to other data and sensor signals S, may also take into account, in particular, the vehicle position data of the position detection system 80 and steering angle data of the steering angle sensor 70 and may activate the steering actuator 24 accordingly.

In a user-controlled steering mode, the user or driver specifies the steering commands by rotating the steering wheel 12 and these steering commands are detected by the input angle sensor 16. The control unit 22 activates the steering actuator 24 according to the sensor signals S of the input angle sensor 16 and possibly further signals and data (e.g. of the output angle sensor 26). As a result, hydraulic pressure coming from the hydraulic pump 50 may be conducted to the steering cylinder 42 via the steering control unit 40 for the desired steering of the wheels 36. To provide feedback to the user or driver which is representative of the driving situation, the control unit 22 may activate the input actuator 20 to generate a rotational movement of the input steering column 28 which corresponds to the driving situation.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A utility vehicle with hydrostatic steering, comprising:
a steering wheel which is mechanically separate from the wheels of a vehicle axle;
a hydraulic steering control unit via which a hydraulic pressure can be conducted into a hydraulic steering cylinder of a steering device for the wheels according to a rotational movement of the steering wheel;
an input angle sensor configured to detect a rotational movement of the steering wheel;
an output steering column, which is mechanically separate from the steering wheel, can be rotated via a steering actuator and acts on the hydraulic steering control unit; and
a control unit connected to the input angle sensor and to the steering actuator to activate the steering actuator according to sensor signals of the input angle sensor.

2. The utility vehicle of claim 1, further comprising an output angle sensor configured to detect a rotational movement of the output steering column, the control unit connected to output angle sensor.

3. The utility vehicle of claim 1, further comprising an input actuator configured to rotate the steering wheel, the control unit connected to the input actuator.

4. The utility vehicle of claim 1, further comprising a torque sensor configured to detect a rotational movement of the steering wheel, the control unit connected to the torque sensor.

5. The utility vehicle of claim 1, further comprising an input steering column connected to the steering wheel in a rotationally fixed manner, the input steering column being mechanically separate from the output steering column, one or more of the input angle sensor and the torque sensor configured to detect the rotational movement of the steering wheel, and the input actuator configured to rotate the steering wheel.

6. The utility vehicle of claim 1, wherein one or more of a generator of the utility vehicle and an electrical storage unit is connected to one or more of the steering actuator and the input actuator, and the generator is connected to a storage unit input of the electrical storage unit.

7. The utility vehicle of claim 1, wherein the steering actuator acts on a hydraulic pump of the hydraulic steering control unit to generate hydraulic pressure for the steering cylinder.

8. The utility vehicle of claim 1, further comprising an automatic unit connected to one or more of a user interface, a position detection system, and a vehicle-related control device of the utility vehicle, the control unit connected to the automatic unit.

9. The utility vehicle of claim 1, further comprising a steering angle sensor arranged in the region of the vehicle axle, the control unit connected to the steering angle sensor.

10. The utility vehicle of claim 1, wherein the hydraulic steering control unit is hydraulically interconnected between a hydraulic pump, which is driven by a drive motor of the utility vehicle, and the steering cylinder.

11. A hydrostatic steering system for a utility vehicle, comprising:
a steering wheel which is mechanically separate from the wheels of a vehicle axle;
a hydraulic steering control unit via which a hydraulic pressure can be conducted into a hydraulic steering cylinder of a steering device for the wheels according to a rotational movement of the steering wheel;
an input angle sensor configured to detect a rotational movement of the steering wheel;
an output steering column, which is mechanically separate from the steering wheel, can be rotated via a steering actuator and acts on the hydraulic steering control unit; and
a control unit connected to the input angle sensor and to the steering actuator to activate the steering actuator according to sensor signals of the input angle sensor.

12. The hydrostatic steering system of claim 11, further comprising an output angle sensor configured to detect a rotational movement of the output steering column, the control unit connected to output angle sensor.

13. The hydrostatic steering system of claim 11, further comprising an input actuator configured to rotate the steering wheel, the control unit connected to the input actuator.

14. The hydrostatic steering system of claim 11, further comprising a torque sensor configured to detect a rotational movement of the steering wheel, the control unit connected to the torque sensor.

15. The hydrostatic steering system of claim 11, further comprising an input steering column connected to the steering wheel in a rotationally fixed manner, the input steering column being mechanically separate from the output steering column, one or more of the input angle sensor and the torque sensor configured to detect the rotational movement of the steering wheel, and the input actuator configured to rotate the steering wheel.

16. The hydrostatic steering system of claim 11, wherein one or more of a generator of the utility vehicle and an electrical storage unit is connected to one or more of the steering actuator and the input actuator, and the generator is connected to a storage unit input of the electrical storage unit.

17. The hydrostatic steering system of claim 11, wherein the steering actuator acts on a hydraulic pump of the hydraulic steering control unit to generate hydraulic pressure for the steering cylinder.

18. The hydrostatic steering system of claim 11, further comprising an automatic unit connected to one or more of a user interface, a position detection system, and a vehicle-related control device of the utility vehicle, the control unit connected to the automatic unit.

19. The hydrostatic steering system of claim 11, further comprising a steering angle sensor arranged in the region of the vehicle axle, the control unit connected to the steering angle sensor.

20. The hydrostatic steering system of claim 11, wherein the hydraulic steering control unit is hydraulically interconnected between a hydraulic pump, which is driven by a drive motor of the utility vehicle, and the steering cylinder.
